(19) United States
(12) Patent Application Publication
(10) Pub. No.: US 2008/0037256 A1
(43) Pub. Date: Feb. 14, 2008

(54) Heat conductor assembly of light source

(76) Inventor: Chi-Mao Li, Taipei City (TW)

Correspondence Address: Chi-Mao Li, 235 Chung-Ho, Box 8-24, Taipei, omitted

(21) Appl. No.: 11/503,056

(22) Filed: Aug. 14, 2006

(51) Int. Cl. F21V 29/00

(52) U.S. Cl. 362/294

(57) ABSTRACT

A heat conductor assembly of a light source comprises a light emitting unit for illuminating light; a heat conductive seat for supporting the light emitting unit and having at least one pin or at least one joint for being connecting to a power source; and the heat conductive seat being heat conductive for dissipating heat from the light emitting element; a lampshade cup being made of heat conductive material; and at least one heat conductive sheet installed on the lampshade cup for contacting with a casing of a lamp so as to transfer heat; and thus the casing being formed as a heat dissipation portion. A periphery of the lampshade cup is formed with a plurality of heat conductive sheets, one end of each heat conductive sheet is fixed to the lampshade cup, and another end thereof extends out from the lampshade cup to contact with the casing.

### FIELD OF THE INVENTION

The present invention relates to lamps, in particular to a heat conductor assembly of a light source, wherein a plurality of longitudinal recesses are formed at the periphery of the lampshade cup for retaining the heat conductive sheet so as to enlarge the contact area with air. Thus, the heat dissipation efficiency is increased. A plurality of heat conductive sheets are installed at a periphery of a lampshade cup and are spaced equally. One end of each heat conductive sheet is cambered so as to increase the contact area with lamp casing so that heat can be dissipated more rapidly. Furthermore, power and illumination of the light emitting diode can be promoted greatly so that the chips required are less than the prior art. Thereby the light emitting elements have longer lift time. The cost of material is saved.

### BACKGROUND OF THE INVENTION

Referring to FIGS. 1 and 1-1, a prior art lamp 1 with LEDs light source is illustrated. The prior art is widely used, such as used as a projection light, a flashlight, a car light, an infrared light, an ultraviolet light, an illumination light, such as a table light, a traffic light, an indoor light, a navigation light, etc. The lamps provide steady light illumination. If high illumination light is required, the number of LEDs in the lamp must be increased, but the heat dissipated is also increased.

In the prior art lamp 1,the heat is dissipated to air by an inner edge thereof. The inner edge is also installed with a plurality of LEDs 12. When the lamp is actuated, the LEDs 12 will light up and thus heat is generated. The heat is transferred to air from the edge 11. The prior art lamp is installed in the casing 12 of a lamp. The lampshade cup 10 do not contact the casing 13. Heat cannot be effectively transferred to the casing 13. The heat dissipation is not preferred and thus the temperature of the lamp is high. As a result, lifetime of the lamp is reduced. Thus current in the prior art lamp is limited. The power of the chip and the illumination of the lamp cannot be increased effectively. Thus, the E series lamps, MR series lamps, or LEDs lamps with standard joints are confined in illumination due to deficiency in heat dissipation. As a result, these kinds of lamps have high cost, large volume, short lifetime and is thus not competitive commercially.

### SUMMARY OF THE INVENTION

Accordingly, the primary object of the present invention is to provide a heat conductor assembly of a light source, wherein a plurality of longitudinal recesses being formed at the periphery of the lampshade cup for retaining the heat conductive sheet so as to enlarge the contact area with air. Thus, the heat dissipation efficiency is increased. A plurality of heat conductive sheets are installed at a periphery of the lampshade cup and are spaced equally. One end of each heat conductive sheet is cambered so as to increase the contact area with lamp casing so that heat can be dissipated more rapidly. Furthermore, power and illumination of the light emitting diode can be promoted greatly so that the chips required are less than the prior art. Thereby the light emitting elements have longer lift time. The cost of material is saved.

To achieve above obj ects, the present invention provides a heat conductor assembly of a light source which comprises a light emitting unit for illuminating light; a heat conductive seat for supporting the light emitting unit and having at least one pin or at least one joint for being connecting to a power source; and the heat conductive seat being heat conductive for dissipating heat from the light emitting element; a lampshade cup being made of heat conductive material; and at least one heat conductive sheet installed on the lampshade cup for contacting with a casing of a lamp so as to transfer heat; and thus the casing being formed as a heat dissipation portion. A periphery of the lampshade cup is formed with a plurality of heat conductive sheets, one end of each heat conductive sheet is fixed to the lampshade cup, and another end thereof extends out from the lampshade cup to contact with the casing.

The various objects and advantages of the present invention will be more readily understood from the following detailed description when read in conjunction with the appended drawing.

### BRIEF DESCRIPTION OF THE DRAWINGS

FIG. 1 is a perspective view of the LDE lamp of the prior art.

FIG. 1-1 is a cross sectional view about the prior art lamp.

FIG. 2 is a perspective view of the heat conductor assembly of a light source of the present invention.

FIG. 3 is a cross sectional view of the heat conductor assembly of a light source and the lamp casing according to the present invention.

FIG. 4 is a schematic view of the first preferred embodiment of the present invention.

FIG. 5 is a schematic view of the third preferred embodiment of the present invention.

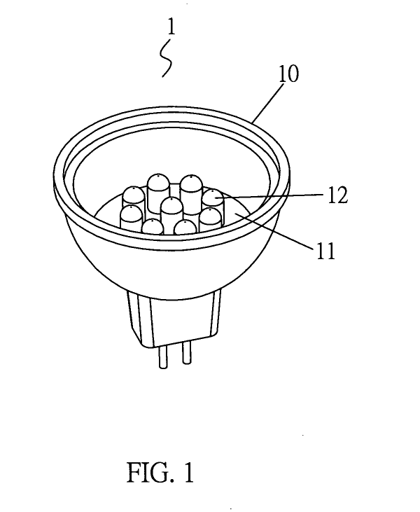

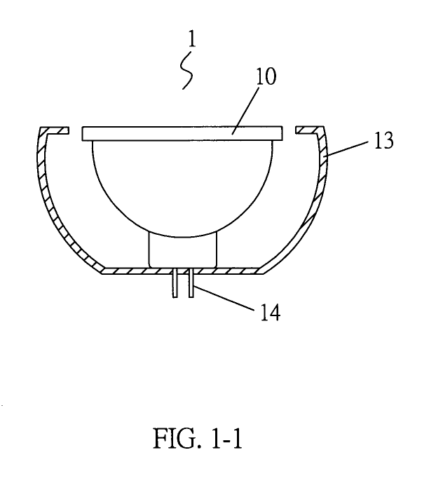

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

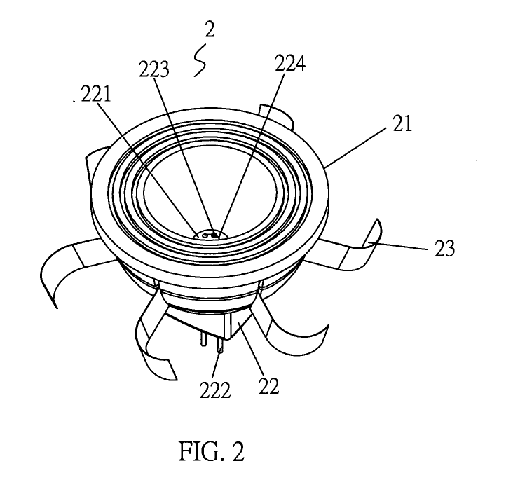

Referring to FIG. 2, the heat conductor assembly of a light source of the present invention is illustrated. The present invention can be used to various bulbs. The heat conductor assembly of a light source has the following elements.

A lampshade cup 21 is a plurality of annular recesses 211 at an upper side thereof so as to increase the contact area between the lampshade cup 21 and air. Thus it has a preferred heat dissipation effect.

A heat conductive seat 22 is installed below the light heat conductor unit 2. A lower side of the heat conductive seat 22 has a plurality of pins 222. An upper side of the heat conductive seat 22 is a supporting surface 221 for installing a chip 223 of light emitting diodes and metal wires 224.

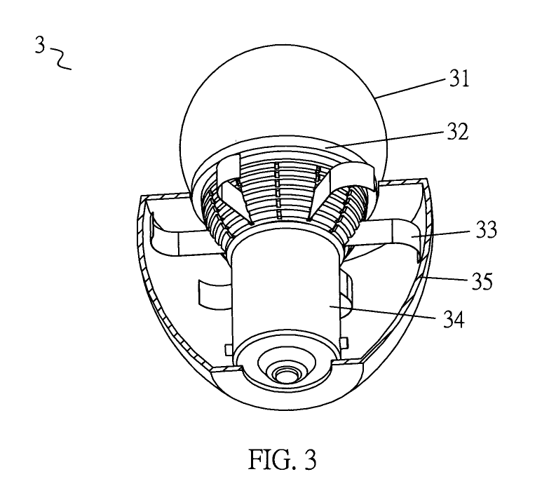

Referring to FIG. 3, the cross sectional view of another embodiment of the present invention is illustrated. As illustrated in the drawings, an upper edge of the lampshade cup 32 below the lampshade 31 is enlarged so that the annular recesses at an upper side thereof can contact a casing 35 of a lamp. Thus, heat from the lampshade cup 32 can be transferred to the casing 35. A periphery of the lampshade cup 32 is formed with a plurality of heat conductive sheets 33 which are spaced with an equal distance. One end of each heat conductive sheet 33 has a cambered shape. All the cambered shape ends have the same orientation so that the ends of the heat conductive sheets 33 can tightly contact the casing 35. The heat conductive sheets 33 have the effects of increasing the area to contact air and further increasing the heat transferring to the casing. Thereby the heat dissipation of the heat conductor assembly of a light source 3 of the present invention is better than the prior art lamp structure. A lower end of the lampshade cup 32 is retained with a connecting joint 34 which can be screwed to a lamp seat of a car. An annular isolator is installed between the lampshade cup 32 and the joint 34 to avoid the joint 34 to conduct the electric power to the lampshade cup 21. Thus the maintenance and use of the heat conductor assembly of a light source 3 of the present invention are safe.

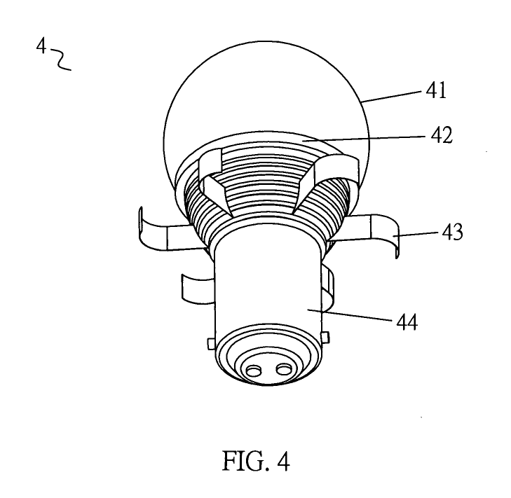

Referring to FIG. 4, it is illustrated that the heat conductor assembly of a light source 42 is installed at a lower side of the lampshade 41. A lower end of the lampshade cup 42 is installed with a connecting joint 44. The joint 44 can be installed to a lamp seat of a car. An annular isolator is installed between the lampshade cup 42 and the joint 44 to avoid the joint 44 to conduct the electric power to the lampshade cup 42. Thus the maintenance and use of the heat conductor assembly of a light source 4 of the present invention are safe.

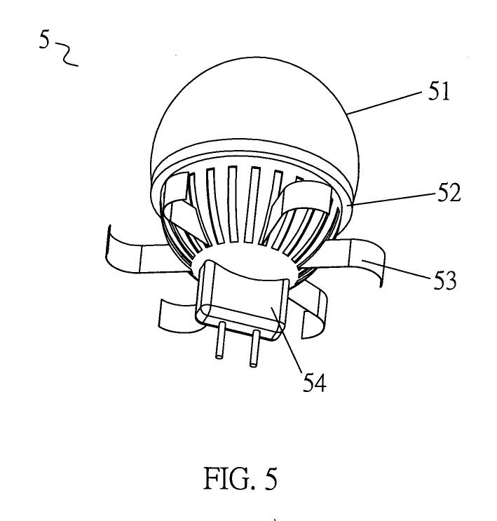

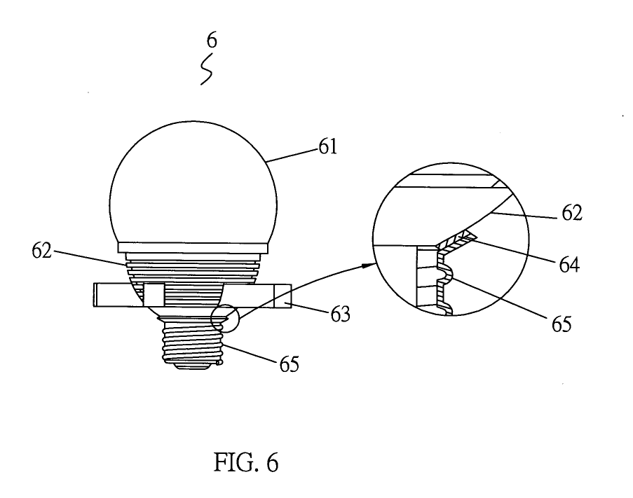

Referring to FIG. 5, it is illustrated that the heat conductor assembly of a light source 5 of the present invention is applied to an MR wall lamp. A lampshade cup 52 is installed below a lampshade 51. A joint 54 extends from a lower end of the lampshade cup 52. The joint 54 can be inserted to a lamp seat of a wall lamp. The heat conductive sheet 53 has the effect of increasing a contact area to contact air so that heat can be dissipated rapidly.

Referring to FIG. 6, the heat conductor assembly of a light source 6 of the present invention can be applied to an E lamp. A lampshade cup 62 is installed at a lower side of the lampshade 61. A screw joint 65 extends from a lower end of the lampshade cup 62. The joint 65 can be screwed to a home used lamp seat. An annular isolator 64 is installed between the lampshade cup 62 and the joint 65 to avoid the joint 65 to conduct the electric power to the lampshade cup 62. Thus the maintenance and use of the heat conductor assembly of a light source 6 of the present invention are safe. When the screwed joint 65 is screwed to a home used lamp seat, the heat conductive sheet 63 has the effect of enlarging an area to contact air and to dissipate heat rapidly.

Advantages of the present invention will be described hereinafter. a plurality of longitudinal recesses are formed at the periphery of the lampshade cup for retaining the heat conductive sheet so as to enlarge the contact area with air. Thus, the heat dissipation efficiency is increased. A plurality of heat conductive sheets are installed at a periphery of the lampshade cup and are spaced equally. One end of each heat conductive sheet is cambered so as to increase the contact area with lamp casing so that heat can be dissipated more rapidly. Furthermore, power and illumination of the light emitting diode can be promoted greatly so that the chips required are less than the prior art. Thereby the light emitting elements have longer lift time. The cost of material is saved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A heat conductor assembly of a light source comprising: a light emitting unit for illuminating light;
a heat conductive seat having at least one pin or at least one joint for being connected to a power source; and the heat conductive seat being heat-conductive for dissipating heat from the light emitting element;
a lampshade cup for supporting the light emitting unit or receiving a lampshade being made of heat conductive material; a lower side of an inner surface of the lampshade cup having a supporting surface for installing the light emitting unit and metal wires; and
at least one heat conductive sheet installed on the lampshade cup for contacting with a casing of a lamp so as to transfer heat; and thus the casing being formed as a heat dissipation portion.

2. The heat conductor assembly of a light source as claimed in claim 1, wherein a periphery of the lampshade cup is formed with a plurality of heat conductive sheets, one end of each heat conductive sheet is fixed to the lampshade cup, and another end thereof extends out from the lampshade cup to contact with the casing.

3. The heat conductor assembly of a light source as claimed in claim 1, wherein heat conductive seat is installed to one of a vehicle lamp, an E type lamp, a MR lamp, and LED lamps.

4. (canceled)

5. The heat conductor assembly of a light source as claimed in claim 1, wherein the light emitting element is one of a vehicle lamp, an E type lamp, a MR lamp, and LED lamps.
